(19) United States
(12) Patent Application Publication
(10) Pub. No.: US 2017/0090825 A1
(43) Pub. Date: Mar. 30, 2017

(54) Firmware and Software Installation in a Decentralized Environment

(71) Applicant: KYOCERA Document Solutions Inc., Osaka (JP)

(72) Inventors: Oleksandr Osadchyy, Concord, CA (US); Jette Cantiller, Hercules, CA (US)

(21) Appl. No.: 14/871,828

(22) Filed: Sep. 30, 2015

(51) Int. Cl. G06F 3/12

(52) U.S. Cl. CPC G06F 3/123; G06F 3/1206; G06F 3/1286; G06F 3/1291; G06F 3/1236

(57) ABSTRACT

Example systems and methods are disclosed for retrieving and installing a software package on a set of printing devices. An example method may include determining to begin retrieval and installation of a software package for a set of printing devices that includes a caching printing device and corresponding target printing devices. The method may include providing the software package to a data store. The method may include generating a key with an expiration time permitting access to the data store. The method may include sending the key to the caching printing device to retrieve the software package from the data store before the expiration time. The method may include receiving, at a server, status updates from the target printing devices during retrieval of the software package. The method may include receiving, at the server, completion reports from the set of printing devices after installation of the software package.

### BACKGROUND

Printing devices have increased in number and geographic footprint throughout the world and have become increasingly connected to networks. As a result, management and maintenance of printing devices has become more complex. Improving and/or simplifying management and maintenance of printing devices can enhance customer satisfaction and generate positive business results. Improving software installation on printing devices using networks can improve management and maintenance of printing devices, thereby increasing customer satisfaction.

### SUMMARY

In a first aspect, a method including determining to begin retrieval and installation of a software package at a first set of printing devices including a first set of target printing devices and a first caching printing device that corresponds to the first set of target printing devices; providing the software package to a first data store; generating a first key with a first expiration time permitting access to the first data store; sending the first key to the first caching printing device, wherein the first caching printing device retrieves the software package from the first data store with the first key before the first expiration time; receiving, at the server, one or more status updates from the one or more first set of printing devices while the first set of target printing devices retrieve the software package from the first caching printing device; and receiving, at the server, one or more completion reports from the one or more first set of printing devices after the first set of printing devices install the software package.

In a second aspect, a method including receiving, from a server, a key with an expiration time granting access to a software package on a data store before the expiration time, wherein the key is received by a caching printing device of a set of printing devices including a set of target printing devices corresponding to the caching printing device; retrieving the software package from the data store using the key before the expiration time; providing a notification to the server indicating completion of retrieval of the software package by the caching printing device to initiate retrieval and installation of the software package by the target printing devices; and providing the software package to the set of target printing devices.

In a third aspect, a system including a first set of printing devices including a first caching printing device; and a first set of target printing devices corresponding to the first caching printing device; a first data store; and a server including one or more processors; and a memory storing instructions that when executed by the one or more processors causes the server to perform functions including determining to begin retrieval and installation of a software package at the first set of printing devices; providing the software package to a first data store; generating a first key with a first expiration time permitting access to the first data store; sending the first key to the first caching printing device, wherein the first caching printing device retrieves the software package from the first data store with the first key before the first expiration time; receiving one or more status updates from the one or more first set of printing devices while the first set of target printing devices retrieve the software package from the first caching printing device; and receiving one or more completion reports from the one or more first set of printing devices after the first set of printing devices install the software package.

These, as well as other aspects, alternatives, and advantages, will become apparent to those of ordinary skill in the art by reading the following detailed description, with reference where appropriate to the accompanying drawings.

### BRIEF DESCRIPTION OF THE DRAWINGS

FIG. 1 illustrates an example printing network, according to an example embodiment.

FIG. 2 is a schematic block diagram illustrating an example computing device, according to an example embodiment.

FIG. 3 illustrates a communication flow diagram, according to an example embodiment.

FIG. 4 shows a flowchart for a method, according to an example embodiment.

FIG. 5 shows a flowchart for a method, according to an example embodiment.

### DETAILED DESCRIPTION

In the following detailed description, reference is made to the accompanying figures, which form a part hereof. It should be understood, however, that the arrangements described herein are set forth as examples only. As such, those skilled in the art will appreciate that other arrangements and elements (e.g., machines, interfaces, functions, orders of functions, etc.) can be used instead or in addition. Further, many of the elements described herein are functional entities that may be implemented as discrete or distributed components or in conjunction with other components, and in any suitable combination and location. Various functions described herein as being performed by one or more entities may be carried out by hardware, firmware or software logic. For instance, various functions described herein may be carried out by a processor executing instructions written in any suitable programming language and stored in memory.

In this description, the articles “a” or “an” are used to introduce elements of the example embodiments. The intent of using those articles is that there is one or more of the elements. The intent of using the conjunction “or” within a described list of at least two terms is to indicate any of the listed terms or any combination of the listed terms. The use of ordinal numbers such as “first,” “second,” “third” and so on is to distinguish respective elements rather than to denote a particular order of those elements.

### I. OVERVIEW

In order to maintain and manage printing devices effectively, printing devices may occasionally need firmware and/or software updates. For printing devices connected to a cloud server via a network, the printing devices may update their firmware and/or software by downloading the software package from the cloud server via the network. However, a centralized environment relying on a cloud server to provide one or more software packages to one or more printing devices may be challenging for at least two reasons.

First, the cloud server may have limited resources to concurrently provide one or more software packages to multiple printing devices. As a result, a printing device may have to wait to download the software package because the cloud server is busy providing the software package to one or more other printing devices. Second, the cloud server may be located far away from one or more of the printing devices. The download time of the software package from the remote cloud server to the printing devices may be increased due to the large physical distance between the remote cloud server and the printing devices.

To overcome these challenges, a system may execute a method relying on a cloud server and one or more data stores. The cloud server may provide one or more software packages to the one or more data stores. The cloud server may then generate a key for accessing a data store to download the software package prior to the expiration time. The cloud server may send the key to a caching printing device for a set of printing devices. The caching printing device may then use the key to download the software package prior to the expiration time.

Next, the cloud server may indicate to a set of target printing devices within the set of printing devices that correspond to the caching printing device that the software package is available. The target printing devices may then retrieve and download the software package from the corresponding caching printing device. The target printing devices may send status updates to the cloud server during the retrieval of the software package. Additionally, the target printing devices may send completion reports to the cloud server after installation of the software package at the target printing devices.

The system may provide one or more software packages to the one or more printing devices in a decentralized environment by employing one or more data stores. By using multiple data stores to have a distributed storage, the one or more software packages can be downloaded concurrently from at least the first data store and the second data store. Second, the cloud server may select the particular data store based on its location relative to a caching printing device downloading the software package stored on the selected data store. Thus, the physical distance between the data store with the software package and the caching printing device downloading the software package can be reduced to a value lower than the physical distance between the caching printing device and the cloud server. Thus, increased concurrent downloads and decreased physical distance can reduce software package download times for a caching printing device.

The system may rely on encrypted keys to provide a caching printing device access to the software package on a data store. Keys ensure that the software package is downloaded to an authorized caching printing device in a secure manner. Additionally, because the keys are provided by the cloud server to caching printing devices, the cloud server can still maintain control over the distribution of the software package to selected caching printing devices. The key may have an expiration time that is set to be long enough to allow the caching printing device to have enough time to download the software package, but short enough to prevent unsecure and/or unauthorized access to the data store and software package by unauthorized devices.

A caching printing device may initially download the software package using the key from a data store before the expiration time. The caching printing device may then provide the software package to one or more corresponding target printing devices. A set of printing devices including the caching printing device and target printing devices may be coupled by a local network. Download times associated with the target printing devices downloading the software package may be reduced by relying on a local caching printing device, as opposed to the cloud server or remote data store for a few reasons.

First, the physical distance between the local caching printing device and target printing devices may be smaller than the physical distance between the target printing devices and the cloud server and/or remote data stores. Second, concurrent downloads of one or more software packages to multiple printing devices may be increased by using multiple caching printing devices, as opposed to being bottlenecked by the available resources of the cloud server and remote data stores. Also, the data transfer rate on the local network may be higher than the data transfer rate on the network connecting the target printing devices to the cloud server and/or the remote data store.

The cloud server may use multiple data stores to provide multiple software packages to multiple sets of printing devices. By using multiple data stores, multiple software packages can be downloaded concurrently from the multiple data stores to the multiple sets of printing devices. By employing a distributed storage of the software packages on multiple data stores, multiple caching printing devices can reap the benefit of reduced download times by concurrently downloading software packages from the multiple data stores.

The cloud server can still maintain control in a decentralized environment with distributed storage by sending and receiving messages to the printing devices. The cloud server can send commands to the target printing devices and/or a caching printing device to initiate retrieval and installation of the software package. Further, the cloud server may receive status updates during retrieval of the software package by the target printing devices. Even further, the cloud server may receive completion reports from target printing devices after the installation of the software package. The cloud server may then compile and provide completion reports to an end-user regarding the completed software package installations on the one or more sets of printing devices.

### II. PRINTING DEVICE EXAMPLES

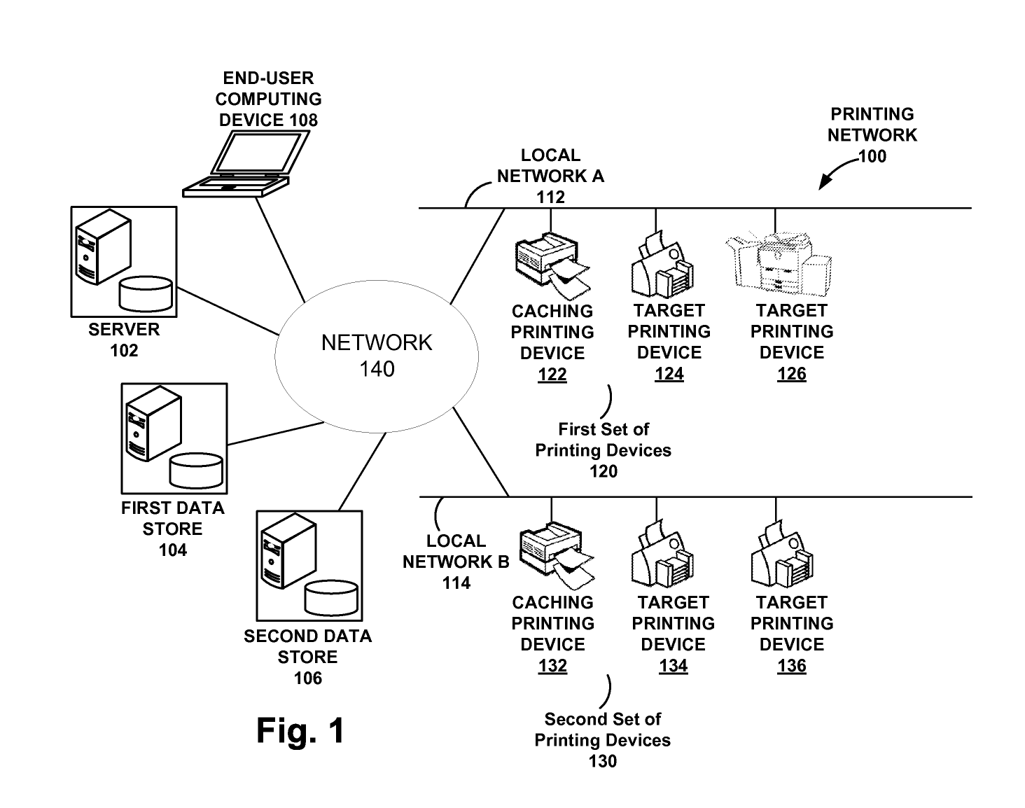

FIG. 1 is a diagram illustrating printing network 100, according to an example embodiment. Printing network 100 includes server 102, first data store 104, second data store 106, and end-user computing device 108 interconnected using network 140. Printing network 100 also includes a first set of printing devices 120 and a second set of printing devices 130. The first set of printing devices includes caching printing device 122, target printing device 124, and target printing device 126 interconnected using local network A 112. The second set of printing devices includes caching printing device 132, target printing device 134, and target printing device 136 interconnected using local network B 114. In some examples, printing network 100 can have more, fewer, and/or different types of servers, end-user computing devices, data stores, caching printing devices, target printing devices, networks, sets of printing devices, and/or printing devices than indicated in FIG. 1.

Server 102 may be a cloud server that can perform various tasks to manage and/or maintain printing devices. Server 102 may communicate commands to printing devices to initiate software and/or firmware installation and/or upgrades, receive messages from printing devices indicating status, failure, and/or completion of firmware and/or software installation and/or upgrades, and/or execute other tasks to manage and/or maintain printing devices. Although FIG. 1 displays server 102 as one computing device, the server 102 may include one or more computing devices that are at the same location, or at various locations. Server 102 may represent, or correspond to, an entity that is the manufacturer of some or all of the first and second set of printing devices 120 and 130. Alternatively, the printing devices 120 and 130 may be manufactured by an entity different than the printing device manufacturer entity corresponding to server 102. Other embodiments are also possible.

The first and second data stores 104 and 106 may be computing devices providing distributed storage accounts located remotely from server 102. Each data store may include one or more computing devices. Each data store may provide secure access to selected and/or authorized devices (such as caching printing devices 122 and 132) to retrieve a software package stored at the data store. Each data store may generate a key to ensure secure access to the software package. The data stores 104 and 106 may receive a software package from server 102 or an end-user computing device 108. The data stores 104 and 106 may correspond to an entity that provides data storage service and is different from the entity corresponding to server 102. Other embodiments are also possible.

Printing devices 122, 124, 126, 132, 134, and 136 can include devices configured to scan, print, copy, e-mail, account for, communicate and/or otherwise process documents and/or files that are originally available either on paper or electronically. In some embodiments, printing devices 122, 124, 126, 132, 134, and 136 can perform other tasks and/or other processing as well. Printing devices 122, 124, 126, 132, 134, and 136 can include products from various manufacturers with variations in color, speed, computing power, functionality, network connectivity, and/or other features.

The first set of printing devices 120 may be interconnected by local network A 112, while the second set of printing devices 130 may be interconnected by local network B 114. The first set of printing devices 120 may correspond to a first entity (such as Company A) while the second set of printing devices 130 may correspond to a second entity (such as company B, which may compete against company A). As a result, the first set of printing devices 120 on local network A 112 (for example, Company A's intranet) may not be able to communicate with the second set of printing devices 130 on local network B 114 (for example, Company B's intranet) via network 140.

However, the first and second set of printing devices may be able to communicate with server 102, data stores 104 and 106, and end-user computing device 108 via network 140 (for example, the Internet) to execute various tasks, such as obtaining a software package. Caching printing devices 122 and 132 may include a memory (such as a disk) for storing a software package. The combination of devices including server 102, data stores 104 and 106, and end-user computing device 108 may be considered a public cloud service that provides the software package to one or both of the first set of printing devices 120 and the second set of printing devices 130. The public cloud service may provide services including firmware upgrade service, firmware storage, and firmware and/or software installation on printing devices.

End-user computing device 108 may include one or more computing devices. Printing environment 100 may include more than one end-user computing device 108. The end-user computing device 108 may communicate with server 102, data store 104, and data store 106 via network 140. The end-user computing device 108 may provide a software package to data stores 104 and 106. Alternatively, the end-user computing device 108 may receive access to a software package stored at a data store from another end-user computing device (not displayed). The end-user computing device 108 may communicate with server 102 to initiate, schedule, and/or configure installation of the software package at printing devices (such as some or all of printing devices 120 and 130). End-user computing device 108 may also receive status and/or completion reports from server 102 regarding installation of a software package.

End-user computing device 108 may correspond to an entity that is different from the entity of server 102. For example, the end-user computing device 108 may correspond to an entity that purchases printing devices, re-brands the printing devices, and distributes the printing devices. The end-user computing device 108 may correspond to an entity that services the printing devices 120 (company A) and/or 130 (company B). In this case, the end-user computing device 108 may be able to communicate with printing devices 120 via network 140 and local network 112 and printing devices 130 via network 140 and local network 114 in order to execute service of the printing devices 120 and/or 130.

In other embodiments, end-user computing device 108 may correspond with the same entity as server 102. Alternatively, the end-user computing device 108 may be a computing device of company A. In this case, while the end-user computing device 108 could access devices 120, device 108 could not access the second set of printing devices 130 (company B). Alternatively, if the end-user computing device 108 was a computing device of company B, the device 108 could access devices 130 (company B), but not devices 120 (company A). Other embodiments may also be possible.

Printing network 100 may support a number of different communication protocols and/or web service technologies to provide effective and/or secure communication between the devices displayed in FIG. 1. The network 100 may support many communication protocols and or web service technologies with fewer restrictions on network configuration (such as restrictions on proxies, firewalls, domain name resolution, etc.). These communication protocols may include, but are not limited to, Extensible Messaging and Presence Protocol (XMPP), File Transfer Protocol (FTP), HyperText Transport Protocol (HTTP), Java Message Service (JMS), Simple Object Access Protocol (SOAP), Short Message Service (SMS), Simple Mail Transfer Protocol (SMTP), Simple Network Management Protocol (SNMP), Transmission Control Protocol/Internet Protocol (TCP/IP), User Datagram Protocol (UDP), Lightweight Directory Access Protocol (LDAP), and the Message Queue (MQ) family of network protocols.

For example, communications over network 140 (such as the Internet) between the cloud server 102 and other devices displayed in network 100 that include requests, commands, and/or statuses may rely on XMPP, WebSocket, or other duplex communication protocols. Further, proxies and/or firewalls may be used to support these types of communications. For another example, communications by devices to the cloud server 102 to post device information, transmit keys and/or links, post software package installation progress, and/or other communications may rely on Representational State Transfer (REST), SOAP, and/or other web service technologies.

Also, the transmission of the software package may rely on different protocols depending on which network is being used. For communications over networks 112 and 114 (such as retrieval of the software package from caching printing devices by local target printing devices), TCP/IP protocol may be used. However, for communications over network 140 (such as the Internet), HTTP or HTTPS may be relied upon for caching printing devices to download the software package from a data store. Other communication protocols and web service technologies may be supported by network 100.

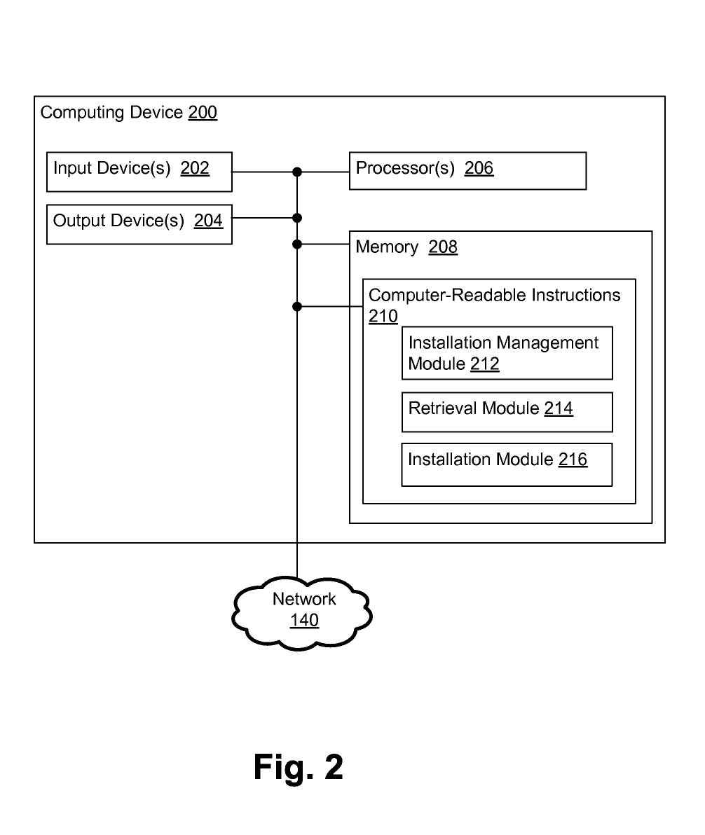

FIG. 2 is a schematic block diagram illustrating computing device 200, according to an example embodiment. In some embodiments, computing device 200 can be configured to perform one or more herein-described functions of printing network 100, server 102, data stores 104 and 106, end-user computing devices 108 and 109, printing devices 122, 124, 126, 132, 134, and 136, networks 112, 114, and 140, methods 400 and 500, and/or part or the entire herein-described functionality related to communication flow 300.

Computing device 200 can include one or more input devices 202, one or more output devices 204, one or more processors 206 and memory 208. Input devices 202 can include user input devices, network input devices, sensors, and/or other types of input devices. For example, input devices 202 can include user input devices such as a touch screen, a keyboard, a keypad, a computer mouse, a track ball, a joystick, a camera, a voice recognition module, and/or other similar devices. Network input devices can include wired network receivers and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network, such as wired portions of networks 112, 114, and/or 140, and/or wireless network receivers and/or transceivers, such as a Bluetooth transceiver, a Zigbee transceiver, a Wi-Fi transceiver, a WiMAX transceiver, a wireless wide-area network (WWAN) transceiver and/or other similar types of wireless transceivers configurable to communicate via a wireless network, such as wireless portions of networks 112, 114, and/or 140 (networks 112 and/or 114 are not displayed in FIG. 2). Sensors can include devices configured to measure conditions in an environment of computing device 200 and provide data about that environment (such as location data). Example sensors include, but are not limited to, GPS sensor(s), location sensors(s), camera(s), light sensor(s), infrared sensor(s), and microphone(s). Other input devices 202 are possible as well.

Output devices 204 can include user display devices, audible output devices, network output devices, and/or other types of output devices. User display devices can include one or more printing components, liquid crystal displays (LCD), light emitting diodes (LEDs), lasers, displays using digital light processing (DLP) technology, cathode ray tubes (CRT), light bulbs, and/or other similar devices. Audible output devices can include a speaker, speaker jack, audio output port, audio output device, headphones, earphones, and/or other similar devices. Network output devices can include wired network transmitters and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network, such as wired portions of network 140, and/or wireless network transmitters and/or transceivers, such as a Bluetooth transceiver, a Zigbee transceiver, a Wi-Fi transceiver, a WiMAX transceiver, a wireless wide-area network (WWAN) transceiver and/or other similar types of wireless transceivers configurable to communicate via a wireless network, such as wireless portions of network 140. Other types of output devices can include, but are not limited to, vibration devices, haptic feedback devices, and non-visible light emission devices; e.g., devices that emit infra-red or ultra-violet light. Other output devices 204 are possible as well.

Processors 206 can include one or more general purpose processors, central processing units (CPUs), CPU cores, and/or one or more special purpose processors (e.g., graphics processing units (GPUs), digital signal processors (DSPs), field programmable gated arrays (FPGAs), application specific integrated circuits (ASICs), etc.). Processors 206 can be configured to execute computer-readable program instructions 210 that are contained in memory 208 and/or other instructions as described herein.

Memory 208 can include non-transitory machine-readable storage configured to store data and/or instructions. In particular, memory 208 can store machine-readable instructions 210 that, when executed by processor(s) 206, can cause a computing device to perform functions, such as but not limited to, functions of herein-described devices, networks, methods, features, and scenarios. In particular, machine-readable instructions 210 can include instructions for herein-described installation management module 212, retrieval module 214, and/or installation module 216. Server 102 may perform functions for installation management module 212, while caching printing devices 122 and 132, as well as target printing devices 124, 126, 134, and 136, perform functions for retrieval module 214 and installation module 216. The functions performed by caching printing devices 122 and 132 for both retrieval module 214 and installation module 216 may be different from the functions performed by target printing devices 124, 126, 134, and 136 for both retrieval module 214 and installation module 216.

These examples of a computing device are provided for illustrative purposes. In addition to and/or alternatively to the examples above, other combinations and/or sub-combinations of printer and computer technologies may also exist, amongst other possibilities, without departing from the scope of the embodiments herein.

### III. COMMUNICATION FLOW DIAGRAM

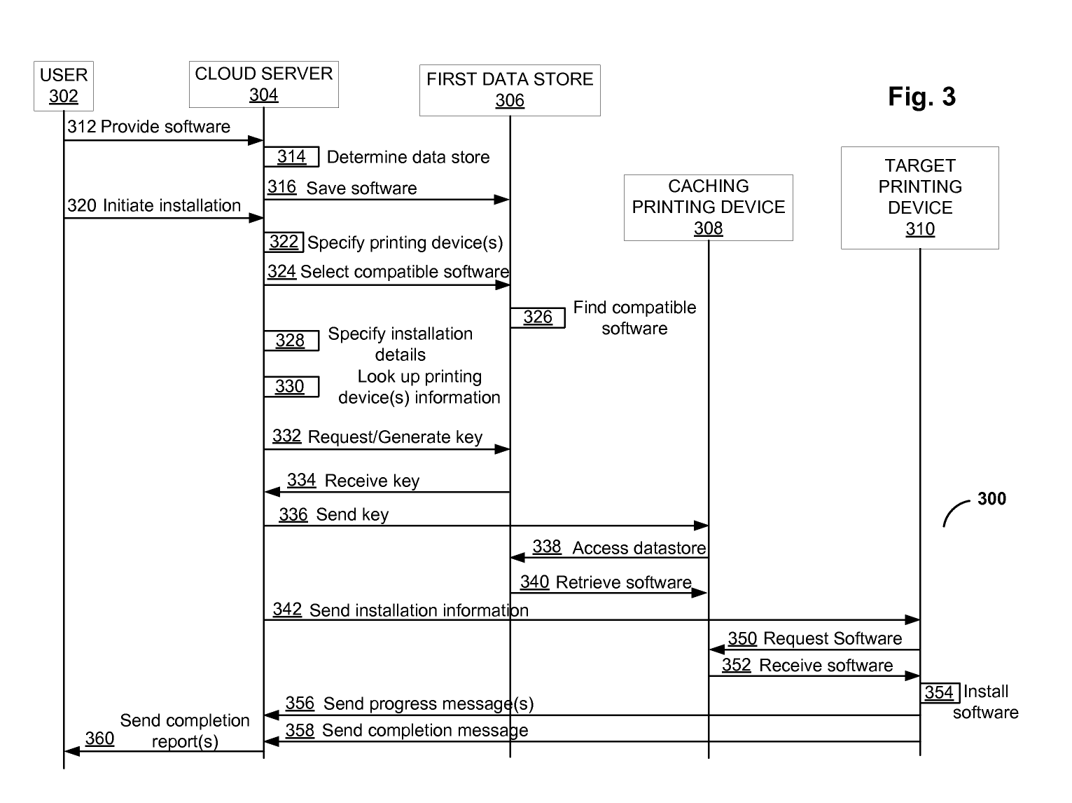

FIG. 3 is a diagram of a communication flow sequence 300 for distributing the software package in a decentralized printing network environment, such as printing network 100 from FIG. 1. FIG. 3 includes a user 302, a cloud server 304, a first data store 306, a caching printing device 308, and a target printing device 310. In some embodiments, the communication flow sequence 300 may occur between more, fewer, and/or different entities than those displayed. The user 302 may correspond with end-user computing device 108 from FIG. 1. Additionally, the cloud server 304 may correspond with server 102 from FIG. 1. Further, the first data store 306, the caching printing device 308, and the target printing device 310 may correspond with the first data store 104, the caching printing device 122, and the target printing device 124, respectively, from FIG. 1.

The sequence 300 may begin with step 312, in which a user 302 provides the software package to cloud server 304. The software package may include firmware revisions, firmware updates, software revisions, software updates, patches, and/or other types of firmware or software to improve maintenance, management, and/or performance of printing devices. Access to the software package may be granted to the user 302 by another user. In particular, the software package may be stored in a data store (such as first data store 306) and shared with user 302 by another user. Other embodiments for providing access to user 302 of the software package also exist.

After the cloud server 304 receives the software package from user 302, the sequence 300 may continue with the cloud server 304 determining where to store the software package. One factor that may be considered when determining which data store to use is the physical location of the data store relative to the physical location of the printing devices that will retrieve and install the software package. A data store that is physically located closer to the target printing devices may shorten the transmission time of the software package from the data store to the printing devices. Other factors may also be considered by cloud server 304 when selecting a data store for storing the software package.

Once the cloud server 304 has determined to store the software package at the first data store 306, the cloud server 304 may then store the software package at first data store 306, as shown by step 316. In some embodiments, the software package may already be stored at first data store 306, which means step 316 may not have to be performed by cloud server 304. In these cases, the cloud server 304 may associate the software package with the user 302, to ensure proper reporting of software package installation completion to the correct user 302. In other embodiments, a different entity (such as user 302) may store the software package at first data store 306. Other embodiments may be possible.

Next, the user 302 may send a message to cloud server 304 to initiate the installation of the software package at one or more target printing devices, as shown by step 320. The message may indicate the printing devices that will install the software package, the time and/or day of the installation of the software package, the particular firmware and/or software to be installed, and/or other miscellaneous details about the software package installation. The user 302 may send one or more messages to the cloud server 304 to initiate the software package installation on the printing devices.

The cloud server 304 may then determine, at step 322, which printing devices will retrieve and install the software package stored at first data store 306. The printing devices may include one or more caching printing devices and one or more target printing devices corresponding to the determined caching printing devices. In one embodiment, the cloud server 304 may designate the specified printing devices from user 302 as the first set of printing devices, and designate one of the first set of printing devices to be the caching printing device.

Referring to FIG. 1, in another embodiment, the software package may be determined to be installed for both the first set of printing devices 120 and the second set of printing devices 130. In this case, the system could use only one data store, such as the first data store 104, or both the first and second data stores 104 and 106, respectively. The server may determine to use two data stores to have the software package downloaded concurrently to the two sets of printing devices, which may or may not be possible using only one data store. The server may also determine to use two data stores based on the physical location of the data stores and the printing devices.

For example, if the first data store 104 is physically located closer to the first set of printing devices 120 and the second set of printing devices 130, then the server may determine to store the software package at only the first data store 104. Alternatively, if the first data store 104 is physically located closer to the first set of printing devices 120 than the second data store 106, and the second data store is physically located closer to the second set of printing devices 130 than the first data store 104, then the server may determine to store the software package at both the first data store 104 and the second data store 106. Further, the server may indicate that the first set of printing devices 120 can retrieve the software package from the first data store 104, while the second set of printing devices 130 can retrieve the software package from second data store 106. By using the second data store, the transmission of the software package to the second set of printing devices 130 may be shortened due to the closer physical location of the second data store 106 to the second set of printing devices 130. Additionally, transmission of the software package from the two data stores 104 and 106 to the two sets of printing devices 120 and 130 may occur concurrently, thereby further reducing the overall transmission time of the software package to the two sets of printing devices 120 and 130.

Based on the specified printing devices, the cloud server 304 may then determine a software package stored at the first data store 306 that is compatible with the specified target devices, as shown by step 324. Multiple software packages may be stored at the first data store 306, which may cause the first data store 306 to search for and determine compatible software that is available to the cloud server 304 for the specified printing devices, as shown by step 326. In other embodiments, the cloud server 304 and first data store 306 may determine and confirm software package compatibility for the specified printing devices using other methods.

The cloud server 304 may then execute step 328 to specify details about the installation of the software package, as seen by step 328. The specified details may be based on the message received from the user 302 during step 320. Miscellaneous details about the software package installation may include whether or not transmission, retrieval, and/or installation of the software package should be automatically attempted again upon failure, the specific times of execution of the transmission, retrieval, and/or installation of the software package, and/or other details about the transmission, retrieval, and/or installation of the software package by the printing devices. Upon completion of step 328, the software package installation may be considered as scheduled at the cloud server 304 for the specified printing devices.

Next, the server 304 may look up device network information for the target printing devices and the caching printing device that will retrieve and install the software package, as shown by step 330. Initially, the cloud server 304 may receive registration information from printing devices, including caching printing device 308 and target printing device 310 (not displayed). After initially receiving the registration information from the printing devices, the cloud server 304 may rely on the registration information multiple times for various firmware and/or software package transmissions, retrievals, and installations. Because the cloud server 304 remembers the registration information from the printing devices, the printing devices do not have to re-register with the cloud server 304 for later software package installations.

The registration information received may indicate the local network system location corresponding to the printing device. Additionally, the registration information may indicate the specific caching printing device corresponding to the printing device. The cloud server 304 may store the registration information indicating a printing device's local network system location and the corresponding caching printing device that distributes firmware and software to the printing devices on that local network. The cloud server 304 may also store the caching printing device location. Other information may be included in the registration information that is stored by cloud server 304.

The cloud server 304 may determine other information about the devices, which may not require registration information. The cloud server 304 may determine available memory at the caching printing device 308. Other information may be determined by the cloud server 304 without using registration information for the printing devices.

The cloud server 304 may then request and receive a key from first data store 306, as shown by steps 332 and 334. The key may be a shared access signature that provides secure access to the software package stored at the first data store 306 to selected devices. The key may be for a specific data store (such as first data store 306) and may have a corresponding expiration time. In some cases, the key may only be allowed to be used once, while in other cases, the key can be used multiple times prior to the expiration time. Further, the key may be encrypted. The cloud server 302 may request the key from the first data store 306 (step 332) and receive the key from the first data store 306 (step 334) after the first data store 306 generates the key. The cloud server 302 may send a message to the caching printing device 308 including a link to the data store, and the key appended to the link (see step 336).

Because the key has an expiration time, the key may only be valid for the amount of time prior to the expiration time. After the expiration time, the key may no longer be valid, and thus may not permit access by a caching printing device to a corresponding data store using the key. The expiration time of the key may be determined by the cloud server 304 and/or the first data store 306. The expiration times may be long enough to permit the caching printing device 308 to download the software package from the first data store 306, but short enough to prevent an unauthorized device from accessing the software package from data store 306 by stealing and/or spoofing the key.

In one embodiment, the expiration key may be determined based on several factors. In particular, factors such as the number of files of the software package, a maximum number of concurrent installations permitted, and the file size of a file within the software package may affect the expiration time. In particular, the expiration time may increase based on an increase in the number of files of the software package, an increase in the file size, and/or a decrease in the number of concurrent installations permitted. In some embodiments, the expiration time (T_{expireTime}) may be determined based on the following formulas:

$$If P max \% C max = 0 , \\ then {T}_{expireTime} = {\sum }_{i = 1}^{i = floor ( \frac{Pmax}{Cmax} ) - 1} A * C max * i )$$

$$If 0 < P max \% C max < C max , \\ then {T}_{expireTime} = {\sum }_{i = 1}^{i = floor ( \frac{Pmax}{Cmax} ) - 1} A ( P max \% C max ) + ( C max * i )$$

where P represents the set of files, Pmax represents the total number of files in P, Cmax represents the maximum number of concurrent downloads from a data store, and Aₙ represents a file size of a file in P. The expiration time determined from the above formulas allows the caching printing device 308 to download the software package from the first data store 306 prior to the determined expiration time of the key.

Once the key has been generated and received by the cloud server 304, the cloud server 304 then sends the key to caching printing device 308, as shown by step 336. As mentioned earlier, the cloud server 304 may send a message including a link to the specific, corresponding data store (such as first data store 306) and the key appended to the link. Once the message is received by the caching printing device 308, the caching printing device can use the key to access the software package from the first data store 306 using the link in the message.

The caching printing device 308 may access the first data store 306 using the key (see step 338) and retrieve the software package, as shown by step 340. The caching printing device 308 may include memory (such as a disk) to store the software package. In some embodiments, the caching printing device 308 may send a message to cloud server 304 indicating that the software package has been retrieved by device 308 from the data store 306 (not displayed).

After the software package has been retrieved by the caching printing device 308, the cloud server 304 may send information about the installation of the software package to the target printing device 310, as shown by step 342. The cloud server 304 may send information to the target printing devices 310 indicating the installation details described in step 328. Additionally, the cloud server 304 may send one or more commands to target printing device 310 to initiate retrieval and installation of the software package by target printing device 310. Alternatively, the caching printing device 308 may send one or more commands to target printing device 310 to initiate retrieval and installation of the software package by target printing device 310.

The target printing device 310 may then retrieve the software package from caching printing device 308, as displayed by steps 350 and 352. By retrieving the software package from the caching printing device 308, the target printing device 310 may retrieve the software package faster than from a central server. In particular, the target printing device 310 may not have to wait on a busy central server to complete other data requests before providing the software package to device 310. The software package retrieval time may also be faster for target printing device 310 because the data transfer rate of the local network connecting target printing devices and caching printing devices (see FIG. 1) may be faster than the data transfer rate of the network connecting the target printing device and the central server. For at least these reasons, software package retrieval may be faster by having a caching printing device 308 (as opposed to a central server) provide the software package to a target printing device 310.

The target printing device 310 may also install the retrieved software package, as displayed by step 354. During the retrieval and installation of the software package by target printing device 310, the target printing device 310 may send various messages to the cloud server 304. The target printing device 310 may individually report status and/or failure of the software package retrieval to the cloud server 304 (see step 356). Additionally, the target printing device 310 may individually report completion of the installation of the software package (see step 358). Other messages may also be sent from the target printing device 310 to server 304 about the retrieval and/or installation of the software package at target printing device 310.

After the cloud server 304 has received completion messages from one or more target printing devices, such as target printing device 310, the cloud server 304 may compile the received completion messages and generate a completion report to transmit to the user 302, as shown by step 360. In other embodiments, the sequence 300 includes more, fewer, and/or different steps than those displayed or described. Additionally, in some embodiments, the steps of the sequence 300 may be executed in a different order than the order displayed in or described for FIG. 3. Other sequences for transmitting, storing, retrieving, and/or installing a software package on printing devices in a decentralized environment using distributed storage may also be possible.

### IV. EXAMPLE METHODS

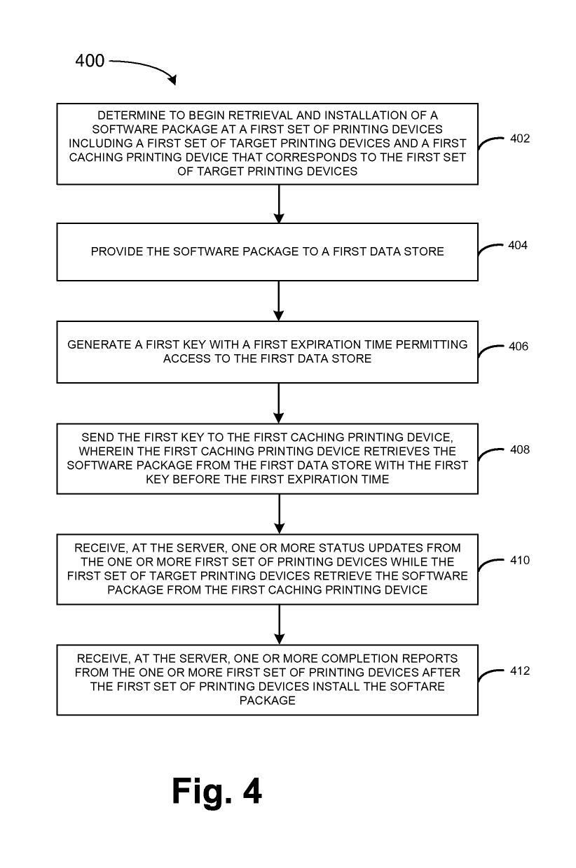

FIG. 4 illustrates a flow chart showing the method 400 that may allow for providing firmware and/or software updates to printing devices, according to an example embodiment. The method 400 may be executed by a cloud server, such as the server 102 displayed in FIG. 1. Other devices or systems may execute method 400 and other embodiments.

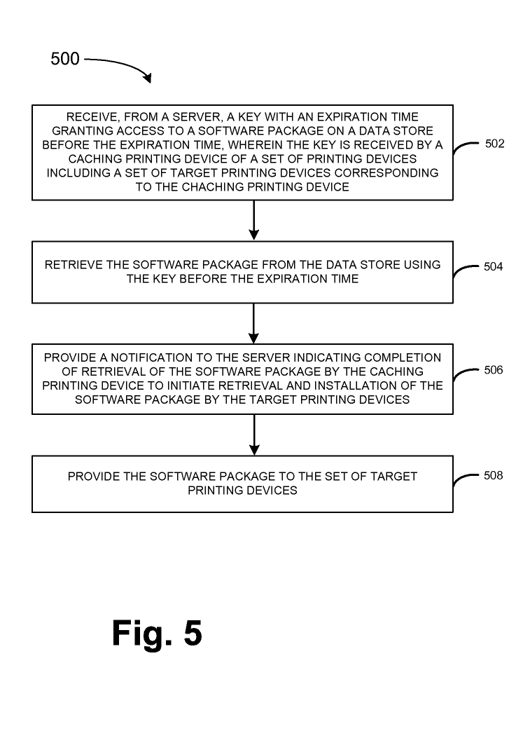

Furthermore, it is noted that the functionality described in connection with the flowcharts described herein can be implemented as special-function and/or configured general-function hardware modules, portions of program code executed by a processor for achieving specific logical functions, determinations, and/or steps described in connection with the flowcharts shown in FIGS. 4 and 5. Where used, program code can be stored on any type of computer-readable medium, for example, such as a storage device including a disk or hard drive.

In addition, each block of the flowcharts shown in FIGS. 4 and 5 may represent circuitry that is wired to perform the specific logical functions in the process. Unless specifically indicated, functions in the flowcharts shown in FIGS. 4 and 5 may be executed out of order from that shown or discussed, including substantially concurrent execution of separately described functions, or even in reverse order in some examples, depending on the functionality involved, so long as the overall functionality of the described method is maintained.

As shown by block 402 of FIG. 4, method 400 may involve determining to begin retrieval and installation of the software package at a first set of printing devices including a first set of target printing devices in the first caching printing device that corresponds to the first set of target printing devices. For example, in FIG. 1, the server 102 may receive a message and/or an indication from end-user computing device 108 to provide a software package to the first set of printing devices 120. In another example, server 102 may send one or more messages to the first set of target printing devices 124 and 126 to initiate retrieval and/or installation of the software package.

Method 400 may further involve providing the software package to a first data store, as displayed by block 404 in FIG. 4. For example, in FIG. 1, the first data store 104 may be at a remote location and connected to the server 102 via a network 140. In other examples, the first data store 104 may be at the same or a similar location as server 102.

Method 400 may also involve generating a first key with a first expiration time permitting access to the first data store, as shown by block 406 in FIG. 4. For example, in FIG. 1, the key may have an expiration time long enough to allow caching printing devices 122 and/or 132 to download the software package. In other examples, the key may have an expiration time short enough to prevent unauthorized devices from accessing the software package at first data store 104.

Method 400 may additionally include sending the first key to the first caching printing device, wherein the first caching printing device retrieves the software package from the first data store with the first key before the first expiration time, as can be seen by block 408 in FIG. 4. For example, in FIG. 1, server 102 may send a message including a link for the first data store 104 to caching printing device 122 to retrieve the software package. For another example, caching printing device 122 may retrieve the software package from the first data store 104 using the network 140.

Method 400 may also include receiving, at the server, one or more status updates from the one or more first set of printing devices while the first set of target printing devices retrieve the software package from the first caching printing device, as displayed by block 410 in FIG. 4. For example, in FIG. 1, target printing devices 124 and 126 may send server 102 one or more status updates during retrieval of the software package from caching printing device 122.

Method 400 may even further include receiving, at the server, one or more completion reports from the one or more first set of printing devices after the first set of printing devices install the software package, as shown by block 412 in FIG. 4. For example, in FIG. 1, target printing devices 124 and 126 may send server 102 one or more completion reports after installation of the software package.

FIG. 5 illustrates a flow chart showing the method 500 that may allow for providing firmware and/or software updates to printing devices, according to an example embodiment. The method 400 may be executed by a caching printing device, such as the caching printing devices 122 and 132 displayed in FIG. 1. Other devices or systems may execute method 500 in other embodiments.

As shown by block 502 of FIG. 5, method 500 may include receiving, from a server, a key with an expiration time granting access to a software package on a data store before the expiration time, wherein the key is received by a caching printing device of a set of printing devices including a set of target printing devices corresponding to the caching printing device. For example, in FIG. 1, caching printing device 122 may receive a key from server 102 to access first data store 104 before an expiration time of the key.

Method 500 may also include retrieving the software package from the data store using the key before the expiration time, as shown by block 504 of FIG. 5. For example, in FIG. 1, caching printing device 122 may access first data store 104 to retrieve a software package before the expiration time of the key.

Method 500 may additionally include providing a notification to the server indicating completion of retrieval of the software package by the caching printing device to initiate retrieval and installation of the software package by the target printing devices, as displayed by block 506 of FIG. 5. For example, in FIG. 1, caching printing device 122 may provide a notification to server 102 after retrieving the software package from first data store 104.

Method 500 may further include providing the software package to the set of target printing devices, as can be seen by block 508 of FIG. 5. For example, in FIG. 1, target printing devices 124 and 126 may retrieve the software package from caching printing device 122 after device 122 has retrieved the software package from first data store 104.

### V. CONCLUSION

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent from the foregoing descriptions. Such modifications and variations are intended to fall within the scope of the appended claims.

With respect to any or all of the ladder diagrams, scenarios, and flow charts in the figures and as discussed herein, each block and/or communication may represent a processing of information and/or a transmission of information in accordance with example embodiments. Alternative embodiments may be included within the scope of such example embodiments. Further, more or fewer blocks and/or functions may be used with any of the ladder diagrams, scenarios, and flow charts discussed herein, and these ladder diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, and/or a tangible storage device.

Additionally, any enumeration of elements, blocks, or steps in this specification, the drawings, or the claims is for purposes of clarity. Thus, such enumeration should not be interpreted to require or imply that these elements, blocks, or steps adhere to a particular arrangement or are carried out in a particular order.

It should be understood that arrangements described herein are for purposes of example only. As such, those skilled in the art will appreciate that other arrangements and other elements (e.g., machines, interfaces, functions, orders, groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting with the true scope and spirit being indicated by the following claims.

1. A method comprising:
determining to begin retrieval and installation of a software package at a first set of printing devices including a first set of target printing devices and a first caching printing device that corresponds to the first set of target printing devices;
providing the software package to a first data store;
generating a first key with a first expiration time permitting access to the first data store;
sending the first key to the first caching printing device, wherein the first caching printing device retrieves the software package from the first data store with the first key before the first expiration time;
receiving, at the server, one or more status updates from the one or more first set of printing devices while the first set of target printing devices retrieve the software package from the first caching printing device; and
receiving, at the server, one or more completion reports from the one or more first set of printing devices after the first set of printing devices install the software package.

2. The method of claim 1, wherein the first set of printing devices are communicatively coupled by way of a local network.

3. The method of claim 1, further comprising:
receiving, at the server, one or more configuration parameters from the first caching printing device configuring retrieving the software package from the first data store.

4. The method of claim 1 further comprising:
determining to begin retrieval and installation of the software package at a second set of printing devices including a second set of target printing devices and a second caching printing device that corresponds to the second set of target printing devices;
providing the software package to a second data store;
generating a second key with a second expiration time permitting access to the second data store;
sending the second key to the second caching printing device, wherein the second caching printing device retrieves the software package from the second data store with the second key before the second expiration time;
receiving, at the server, one or more status updates from the one or more second set of printing devices while the second set of target printing devices retrieve the software package from the second caching printing device; and
receiving, at the server, one or more completion reports from the one or more second set of printing devices after the second set of printing devices install the software package.

5. The method of claim 1, wherein after retrieval of the software package by the first caching printing device, the server provides a notification to the corresponding first target printing devices indicating availability of the software package from the first caching printing device for the first target printing devices.

6. The method of claim 1, further comprising:
receiving registration information for the first set of printing devices, including registration information for the first caching printing device; and
storing, at the server, the registration information of the first set of printing devices, including registration information for the first caching printing device.

7. The method of claim 6, further comprising:
designating, at the server, a plurality of printing devices as the first set of printing devices;
designating, at the server, one of the plurality of printing devices as the first caching printing device; and
sending one or more commands to the first set of printing devices initiating retrieval and installation of the software package.

8. A method comprising:
receiving, from a server, a key with an expiration time granting access to a software package on a data store before the expiration time, wherein the key is received by a caching printing device of a set of printing devices including a set of target printing devices corresponding to the caching printing device;
retrieving the software package from the data store using the key before the expiration time;
providing a notification to the server indicating completion of retrieval of the software package by the caching printing device to initiate retrieval and installation of the software package by the target printing devices; and
providing the software package to the set of target printing devices.

9. The method of claim 8, further comprising:
sending, by the caching printing device, registration information for the set of printing devices, including registration information for the caching printing device.

10. The method of claim 8, wherein the expiration time is based on at least an amount of files within the software package, a file size for the software package, and a maximum number of concurrent retrievals from the data store.

11. The method of claim 8, wherein the set of printing devices are communicatively coupled by way of a local network.

12. The method of claim 8, wherein the server sends one or more commands to the set of target printing devices initiating retrieval and installation of the software package.

13. The method of claim 8, wherein the target printing devices send one or more completion reports to the server after retrieving and installing the software package from the caching printing device.

14. A system comprising:
a first set of printing devices comprising:
a first caching printing device; and
a first set of target printing devices corresponding to the first caching printing device;
a first data store; and
a server comprising:
one or more processors; and
a memory storing instructions that when executed by the one or more processors causes the server to perform functions comprising:
determining to begin retrieval and installation of a software package at the first set of printing devices;
providing the software package to a first data store;
generating a first key with a first expiration time permitting access to the first data store;
sending the first key to the first caching printing device, wherein the first caching printing device retrieves the software package from the first data store with the first key before the first expiration time;
receiving one or more status updates from the one or more first set of printing devices while the first set of target printing devices retrieve the software package from the first caching printing device; and
receiving one or more completion reports from the one or more first set of printing devices after the first set of printing devices install the software package.

15. The system of claim 14, wherein the first expiration time is based on at least an amount of files within the software package, a file size for the software package, and a maximum number of concurrent retrievals from the first data store.

16. The system of claim 14, wherein the instructions further cause the server to perform functions comprising:
receiving, at the server, one or more status updates from the one or more first set of printing devices while the first set of printing devices install the software package.

17. The system of claim 14 further comprising:
a second set of printing devices comprising:
a second caching printing device; and
a second set of target printing devices corresponding to the first caching printing device; and
a second data store, wherein the instructions further cause the server to perform functions comprising:
determining to begin retrieval and installation of the software package at the second set of printing devices;
providing the software package to the second data store;
generating a second key with a second expiration time permitting access to the second data store;
sending the second key to the second caching printing device, wherein the second caching printing device retrieves the software package from the second data store with the second key before the second expiration time;
receiving one or more status updates from the one or more second set of printing devices while the second set of target printing devices retrieve the software package from the second caching printing device; and
receiving one or more completion reports from the one or more second set of printing devices after the second set of printing devices install the software package.

18. The system of claim 14, wherein after retrieval of the software package by the first caching printing device, the server provides a notification to the corresponding first target printing devices indicating availability of the software package from the first caching printing device for the first target printing devices.

19. The system of claim 14, wherein the instructions further cause the server to perform functions comprising:
receiving registration information for the first set of printing devices, including registration information for the first caching printing device; and
storing, at the server, the registration information of the first set of printing devices, including registration information for the first caching printing device.

20. The system of claim 19, wherein the instructions further cause the server to perform functions comprising:
designating, at the server, a plurality of printing devices as the first set of printing devices;
designating, at the server, one of the plurality of printing devices as the first caching printing device; and
sending one or more commands to the first set of printing devices initiating retrieval and installation of the software package.
